(19) United States
(12) Patent Application Publication
(10) Pub. No.: US 2019/0091501 A1
(43) Pub. Date: Mar. 28, 2019

(54) MODULAR AND EXPANDABLE FIRE SUPPRESSION SYSTEM

(71) Applicant: Tyco Fire Products LP, Lansdale, PA (US)

(72) Inventors: Marvin B. Fernstrum, Menominee, MI (US); Brian Lee Counts, Menominee, MI (US)

(73) Assignee: Tyco Fire Products LP, Lansdale, PA (US)

(21) Appl. No.: 16/091,952

(22) PCT Filed: Apr. 6, 2017
(86) PCT No.: PCT/US2017/026394

§ 371 Date: Oct. 5, 2018

Related U.S. Application Data
(60) Provisional application No. 62/320,407, filed on Apr. 8, 2016.

(51) Int. Cl. A62C 37/36; G08B 5/36; G08B 17/06; G08B 17/12

(52) U.S. Cl. CPC A62C 37/04; G08B 17/12; G08B 17/06; G08B 5/36

(57) ABSTRACT

A tire suppression system includes a centralized controller and a plurality of modules (14). Each module includes a housing (30), a printed circuit board (32) with a mounted microprocessor (34), a first connector (36) including a first pair of data wires (38) mounted to the board; and a second connector (40) including a second pair of data wires (42) mounted to the board so that the printed circuit board electrically connects the first and second pairs of data wires. The modules are interconnected with the central controller to define data buses for centralized fire detection, user interface and system response. The connectors of each module interconnect the plurality of modules in series to the central controller.

### PRIORITY CLAIM & INCORPORATION BY REFERENCE

This international application claims the benefit of priority to U.S. Provisional Patent Application No. 62/320,407, filed Apr. 8, 2016, which is incorporated by reference in its entirety.

### TECHNICAL FIELD

This invention relates generally to a fire suppression system for the protection of large machinery, equipment or mobile equipment, and more particularly, to modular components of the system, their assembly and their interconnection.

### BACKGROUND OF THE INVENTION

A fire suppression system for vehicles is shown in international patent application publication in WO 2014/047579. The system shown therein includes components such as user interface display devices, fire detection devices and suppressant releasing devices that are connected to a centralized controller along respective cabled buses for display, detection and release. Devices of a given bus are interconnected with one another by cable connectors. The cables and connectors carry data signals to provide communication between the device and the central controller. The cables and connectors also supply power to devices Far their respective functions. Generally, the connectors and cabling interconnect the devices in a parallel fashion to provide both power and data communication.

Such a parallel connected cable configuration limits the ability to expand the buses. More specifically, the distances between, for example, an interface control module and a detection or release module is limited to two-hundred fifty feet (250 ft.) for proper communication. For large vehicles used, for example, in mining or quarry operations, the distance restriction can be a hindrance to providing the desired fire protection. It is desirable to have a system in which system components can be interconnected to expand the number of components in the system and/or the cabling distance between the components to protect multiple hazard zones of a vehicle or other equipment area to be protected.

### DISCLOSURE OF THE INVENTION

Preferred embodiments of a modular fire suppression system are provided in which the modules of the system are preferably grouped together by type or function and interconnected with one another to a central controller to form one or more data buses for carrying out system functions, such as for example, fire detection, system response or user operations. Preferred embodiments of the modules provide a connector to facilitate the interconnection between modules and the central controller to form the data buses of the system. A preferred embodiment of a fire suppression system includes a centralized controller and a plurality of modules. Each module preferably includes a housing, a printed circuit board with a mounted microprocessor, a first connector including a first pair of data wires mounted to the board, and a second connector including a second pair of data wires mounted to the board so that the printed circuit board electrically connects the first and second pairs of data wires. The modules are interconnected with the central controller to define at least one data bus for centralized fire detection or system response, which preferably includes a user interface bus, a fire detection bus for detecting a fire and a release bus for releasing a suppressant to suppress a fire. The data bus provides for a first end module with its first connector connected to the centralized controller and a second end module with its second connector for connection to another module so that the printed circuit board of each module interconnects the plurality of modules in series to the central controller. By using a preferred modular and serial interconnection of system components, the system can he physically and functionally expanded in the protection of equipment by the addition and interconnection of modules beyond previously known distance limitations while maintaining the benefits of centralized control.

In a preferred aspect the preferred modules and their respective connectors provide for preferred cabling distances between the modules and between the centralized controller that are greater than previously commercially available while maintaining centralized system communication and control. In a preferred aspect, the connector-to-connector wiring between modules can extend up to a maximum of 4000 linear feet. In a preferred user interface bus of the system the preferred interconnections provide for a maximum bus length ranging from 1000 feet to 4000 feet. For a preferred embodiment of the fire detection bus, a maximum bus length preferably ranges from 750 feet to 1500 feet; and in preferred embodiments of the release bus defines a bus length from the central controller to a release module, or from a release module to an actuation assembly of the system, ranges up to a maximum of 250 feet.

### BRIEF DESCRIPTIONS OF THE DRAWINGS

The accompanying drawings, which are incorporated herein and constitute part of this specification, illustrate exemplary embodiments of the invention, and, together with the general description given above and the detailed description and attachments given below, serve to explain the features of the invention.

FIG. 1 is a schematic illustration of one embodiment of a fire suppression system.

FIG. 2 is a schematic illustration of alternate embodiments of a module for use in the system of FIG. 1.

FIG. 2A is an illustrative preferred embodiment of a module showing a wiring bend radius out of the module for use in the system of FIG. 1.

FIG. 3 is a detailed schematic view of data and power wiring in the module of FIG. 3.

FIG. 4 is a schematic of one embodiment of a monitoring circuit for use in the system of FIG. 1.

### DETAILED DESCRIPTION OF THE PREFERRED EMBODIMENTS

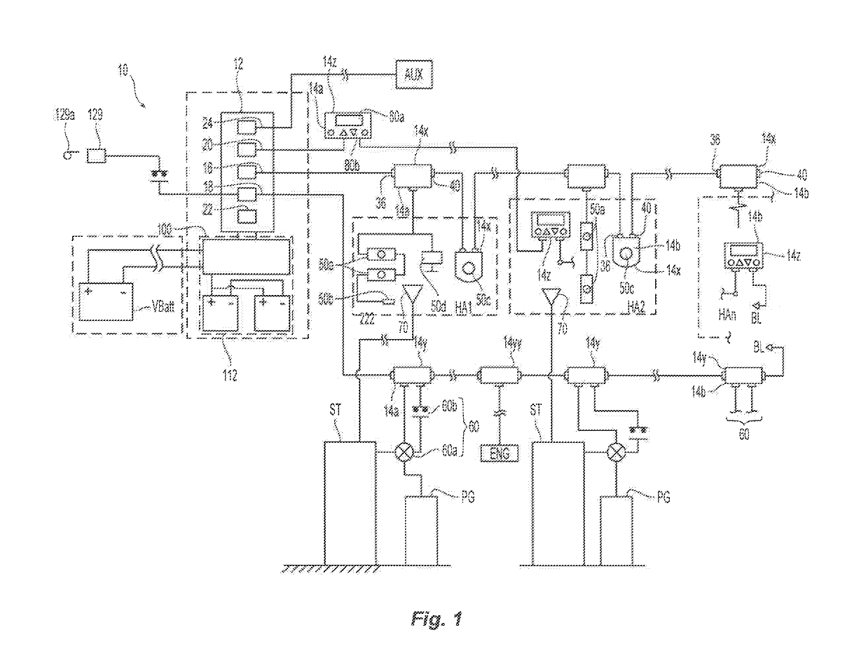

FIG. 1 is a schematic illustration of a preferred embodiment of a fire protection system 10 that preferably provides for continuous monitoring and protection of one or more hazard areas HA. Exemplary hazard area(s) HA protected by the system 10 can include and are not limited to large industrial equipment, machinery or mobile equipment such as for example, generator sets, air compressors, drill rigs, tunnel boring, machines, hydraulic excavators, haul trucks, wheeled loaders, dozers and graders, etc., and the associated areas, such as for example, engine compartments, wheel wells, hydraulic equipment or storage areas for combustible materials. The system 10 is modular with modules interconnected with a central controller. The modules provide a specific or selectively addressable interface between system components and the central controller. Generally, the modules of the system arc one of the following types: a detection module, a release module, or a user interface module. The system 10 and its central controller monitor the one or more hazard areas HA through the detection modules and associated fire detection sensors to detect a fire. If a fire has been detected and identified by the central controller, the central controller addresses the fire through the release modules by operating one or more fluid control assemblies to release a suppressant and distribute the suppressant through one or more nozzles or distribution devices located in the hazard areas HA to preferably suppress the fire. The user interface modules provide owners and operators with an interface to program, update and access the system 10 for its operation, control and historical and/or real-time monitoring. For the preferred embodiments of the system 10 described herein, the centralized controller can address or communicate with the modules of the system individually, selectively, in groups or globally in order to carry out desired fire protection monitoring, response, reporting and/or programming.

The modules of a particular type or function are preferably grouped together and interconnected with one another and the central controller to form a data bus for carrying out one of the centralized functions, such as for example, detection, system response or user operations. Moreover, as described herein, preferred embodiments of the modules provide a connector to facilitate the interconnection between modules and the central controller to form data buses of the system. By using this preferred modular approach, the system 10 can be expanded by the addition and interconnection of modules without any practical limitation while maintaining the benefits of centralized control.

Shown in FIG. 1 is a schematic view of a preferred embodiment of a tire suppression system 10 for the protection of one or more hazard areas HA1, HA2 . . . HAn (collectively HA). The system 10 includes a centralized controller 12 and a plurality of modules 14x, 14y, 14z interconnected with one another to provide for a detection data bus 16, a release data bus 18, and a user interface data bus 20 for centralized fire detection, response and/or system reporting. The system 10 can include additional or other auxiliary power buses 24, such as for example, for powering other associated systems, such as audible alarms, or other detection type devices such as a smoke alarm, which can be connected to the central controller 12 through an appropriately configured detection module. In each data bus, the modules 14x, 14y, 14z are preferably connected in series with one another and the central controller 12.

For the preferred system 10, the modules 14x of the detection bus 16 interconnect the central controller 12 with one or more fire detection devices 50, such as for example, spot thermal detectors 50a, linear thermal detectors 50b, or infra-red (IR)/optical sensors 50c located within the one or more hazard areas HA. Alternatively or additionally, the modules 14x of the detection bus 16 can be coupled to one or more manual actuators, such as for example, an electric manual actuator 50d, for manual suppressant release through the central controller 12. Upon appropriate detection and determination of a fire in a hazard area, the central controller 12 signals for release of suppressant through the modules 14y of the release data bus 18. The modules 14y of the release data bus 18 interconnect the central controller 12 with one or more actuation assemblies 60 for the release of fire suppressant. The system 10 is preferably connected to a supply of suppressant, such as for example, wet and/or dry chemical agent preferably stored in one or more storage tanks ST, for delivery to one or more nozzles or distribution devices 70 located in the hazard area HA. The suppressant is preferably not stored under pressure and therefore a cylinder of pressurizing gas PG is connected to a suppressant storage tank ST for delivering the suppressant to the nozzle 70 under its operating or working pressure. Controlling the release of the pressurizing gas PG into the suppressant tank ST is the preferably electrically operated actuation assembly 60, which is coupled to a module 14y of the release data bus 18. The central controller 12 signals operation of the actuation assemblies 60 through the release modules 14y of the release data bus 18. The modules 14z of the user interface bus 20 provide and interconnect user displays, controls and/or ports for users to access the central controller 12 of the system 10 to program system operations, manually signal operation of the system 10 and/or access history logs and other data on the system 10.

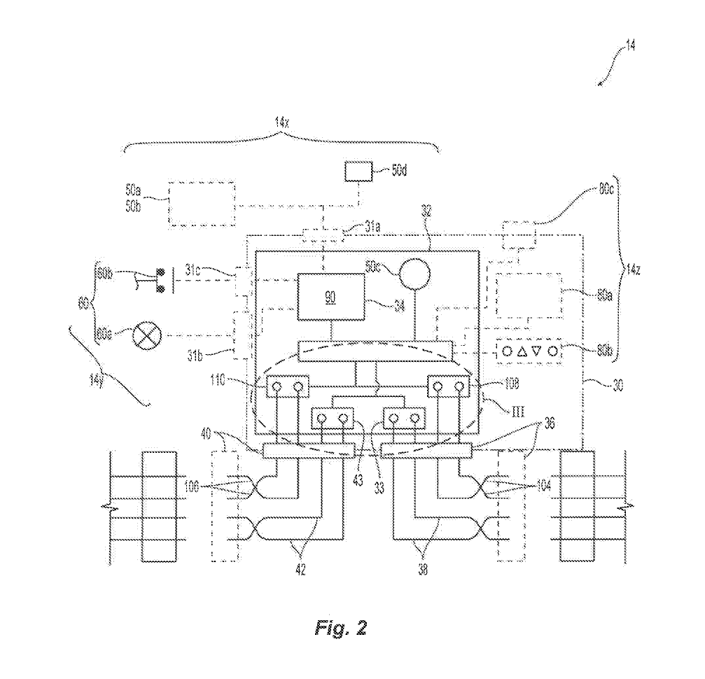

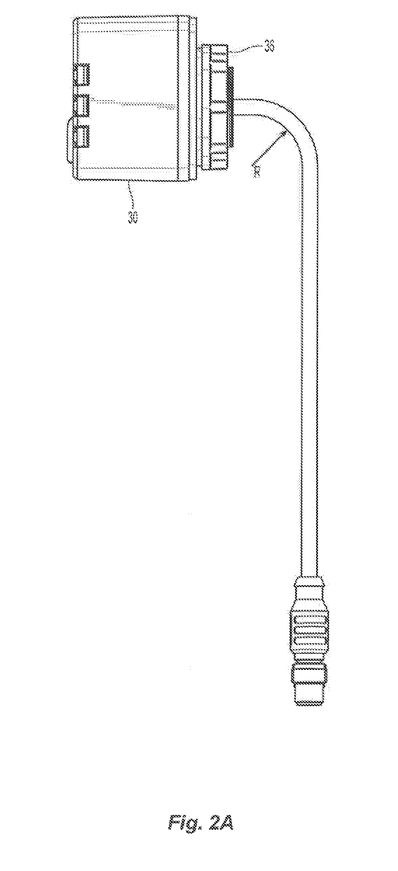

Shown in FIG. 2 is a generalized module 14 representing the various modules 14x, 14y, 14z used of the system 10. The module 14 generally includes a housing 30 and an internal printed circuit board (PCB) 32 with a microprocessor 34 mounted to the printed circuit board 32. Depending upon the type of module 14x, 14y, 14z the microprocessor 34 is connected or coupled with either: (i) an internal or external fire detection or thermal sensor; (ii) an external transducer or other electrically operated device or other digital or analog equipment; or (iii) an input or output device. To form the preferred interconnections described herein for digital communication with the central controller 12, the module 14 includes a first connector 36 having a first pair of data wires 38 mounted to the printed circuit board PCB 32 to farm a first mounting or solder pad 33. The preferred module 14 also includes a second connector 40 having a second pair of data wires 42 mounted to the board 32 to form a second mounting or solder pad 43. With additional reference to FIG. 3, the first and second mounting, pads 33, 43 define a preferred center-to-center spacing D of 0.125 inch. For each of the mounting pads, the pair of data wires extend through a pair of through holes on the printed circuit board that define a center-to-center spacing C that ranges from 0.070 inch to 0.090 inch and is more preferably no less than 0.085 inch. The preferred spacing can provide sufficient spacing and flex in the wiring when enclosed within the housing without shorting. Each of the first and second pairs of data wires 38, 42 forms a twisted pair and defines a preferred twist rate of one inch per twist (1 in./twist) in order to minimize electromagnetic interference (EMI). The printed circuit board 32 electrically connects the first and second pairs of data wires 38, 42 with, for example, a trace or other conductive connection extending between the data wire connections at the printed circuit board 32. Accordingly, the printed circuit hoard 32 forms a bridge between the first and second connectors 36, 40. The connectors of the module can be disposed or fixed about the housing 30 as shown in solid. Alternatively, the connectors 36, 40 can extend loosely from wrapped or shielded wiring that penetrates the housing 30. An illustrative embodiment is shown in FIG. 2A in which the wiring extends out of the display housing with a bend radius. The wiring extends from the module housing 30 to define a preferred minimum bend radius R of two and one-halt inches (2-½ in.). Having the connection wiring extend loosely, from the housing 30 can provide additional flexibility for mounting the modules and associated equipment of the system 10.

Referring again to FIG. 1, the modules 14x, 14y, 14z of the system 10 are interconnected with the central controller 12 to define the one or more preferred data buses 16, 18, 20 for centralized fire detection, response and system reporting. In each data bus, the modules are preferably connected in series with one another and the central controller 12. More specifically, a connector 36, 40 of one module is preferably connected to a connector 36, 40 of the next module in series. The first and second connectors 36, 40 can be physically configured or constructed in a complementary manner to facilitate their interconnection. For example, the connectors 36, 40 can be configured as complementary male and female connectors to facilitate the interconnection between the modules 14x, 14y, 14z and/or the controller 12. Alternatively or additionally, the connectors 36, 40 can be complementary rounded or circular threaded connectors or other complementary pin connectors.

For illustration of the preferred interconnections of the system 10, specific reference is made to the detection data bus 16 shown in FIG. 1. With the modules preferably interconnected in series, each data bus of the system 10 preferably includes a first end module 14a with its first connector 36 connected to the centralized controller 12. At the opposite end of the data bus 16, a second end module 14b has no second connector 40 available for connection to another module or alternatively to serve as a terminating end of the bus. Accordingly, additional modules can be added to second end module 14b of the data bus for expansion of the system 10. Again intermediate the first and second end modules 14a, a connector 36, 40 of one module is preferably connected to a connector 36, 40 of the next module in the series. The module interconnections are preferably funned with an appropriate serial or digital communication cable. More preferably, the module interconnections are made with RS-485 serial communication cable. The data buses 16, 18, 20 are appropriately wired for the RS-485 cable and can be formed as either a half-duplex or full duplex system. To the extent it is desirable to minimize the “drop” or distance from any module connection to the data wires of the RS-485 cable, the preferred mounting of the data wires to the PCB 32 minimizes or eliminates the drop distance. Moreover, the preferred wiring of the system 10 can eliminate or minimize the use of T-connectors and/or end of line terminators.

Use of RS-485 wiring provides system flexibility by providing preferred cabling distances between the modules and between the centralized controller 12 and the modules 14x, 14y, 14z that are greater than previously commercially available while maintaining centralized system communication and control. For example, connector-to-connector wiring can extend up to a maximum of 4000 linear feet. Preferable cabling distances between components can be smaller. In a preferred embodiment of the system 10, the maximum distance from the central controller 12 to the first end module 14a of the release data bus 18, or from any analog device to a module 14y of the release data bus 18, is preferably 250 linear feet. In one preferred aspect, the release data bus 18 defines a total bus length BL that ranges up to a maximum 4000 linear feet from the central controller 12 to the last module 14y in the bus. In another preferred aspect, the detection data bus defines a total bus length BL of up to a maximum of 1500 feet and more preferably 750 linear feet. For the user interface data bus 20, a preferred bus length BL total ranges up to a preferred maximum of up to 4000 feet and more preferably up to a maximum of 1000 feet. Moreover, the user data bus 20 can locate a display device in or proximate any one of the hazard areas HA. Thus, the system 10 can provide for centralized control with multiple user interface locations remotely spaced from the controller 12.

Again for each data bus, the modules on any one particular bus are preferably grouped together based on its type or function. Thus, for example, the modules on the detection data bus 16 are detection type modules. Referring, again to FIG. 2, the type of module is preferably determined by the internal or external components coupled with its microprocessor 34. For example, the module can be configured as a detection module 14x that includes a thermal sensor for fire detection, such as for example, an internal infrared or optical sensor 50c. Alternatively or additionally, the detection module 14x can include an appropriately wired connector 31a and circuitry for connecting the microprocessor 34 to one or more external analog sensors and/or devices, such as for example, a spot thermal detector 50a, a linear thermal detector 50c or a manually operated device 50d for signaling electric-pneumatic actuation to the central controller 12.

For the release data bus 18, the modules are preferably configured as release modules 14y having its microprocessor 34 preferably connected for operation and monitoring of one or more actuation assemblies 60. Referring again to FIG. 1, a preferred actuation assembly 60 includes an electric-pneumatic actuator 60a that operates from an appropriately delivered electrical signal to drive a puncturing member to puncture a rupture disc to discharge the pressuring gas PG for pressurizing the suppressant tank ST. One preferred embodiment of the electric-pneumatic actuator 60a includes a protracting actuation device (PAD). Referring to FIG. 2, in a preferred embodiment of a release module 14y, a connector 31b is preferably configured to be connected to the electric-pneumatic actuator 60a. In a preferred arrangement of the release bus 18, one release module 14y can be connected to and operate up to a preferred maximum of ten (10) electric pneumatic actuators 60a. The actuator 60a is also preferably operated pneumatically in which manually delivered compressed air (not shown) drives the puncturing member. The actuation assembly 60 can include a pressure switch 60b or other flow switch to detect the flow and/or pressure of pressurizing gas. Accordingly, the releasing module 14y preferably includes a connector 31c for connecting the microprocessor 34 to receive signals from the pressure switch 60b for feedback to the central controller 12 regarding the state of pressurizing gas flow. In an alternate embodiment of the release module 14y, the connectors 31b, 31c can be configured as a relay module 14yy for connection to other associated systems of the equipment being protected, such as for example, an engine system ENG, to facilitate communication between the central controller 12 and the engine system to initiate an engine shut down prior to suppressant discharge.

In a preferred embodiment of the user interface bus 20, the modules are configured as display modules 14z. The display module 14z is preferably configured as a user input and output device that can access the central controller and display information to a system user or operator. The display module 14z also preferably provides an input interface for the system user or operator to selectively access, operate, and/or program all or parts of the system 10 through the central controller 12. Accordingly, in a preferred aspect, the user display module 14z includes one or more display devices 80a such as, for example, a liquid crystal display (LCD) screen mounted within the housing 40 of the display module 14z coupled to the microprocessor 34. Additionally or alternatively, the display devices 60a can include an array of LED indicators coupled with the microprocessor 34. Also mounted about the module 14z are one or more control devices 80b coupled with the microprocessor 34 to control the LCD device 80a or other display device and access the central controller 12. The control devices 80b preferably include push buttons, toggle buttons, scroll bars, touch screens, and more preferably, include a switch membrane coupled with the microprocessor 34. One preferred embodiment of the switch membrane includes up and down arrow buttons with one or more selection buttons for accessing, navigating and selecting through operational programs of the system 10 located on the central controller 12. Additionally, the preferred switch membrane 80b includes a button to signal the controller 12 for a manual suppressant release. In another preferred aspect of the display device module 14z, the module preferably includes a digital access connector 80c for access by a computer device or computer storage device, such as for example, a thumb drive. In one preferred embodiment, the digital access connector 80c is embodied as a USB or similar port connection. A system user or operator could access the port 80c with a computer or disc drive using, an appropriately configured connector to download or access system history logs or system programming, update system programming or upload new programming to the central controller 12. As with the connectors 36, 40, the other connectors and/or ports 31a, 31b, 31c, 80c can be disposed in any manner about the housing 30 to facilitate their access and connections.

One or more of the data buses 16, 18, 20 of the system 10 includes a supervisory or monitoring circuit to supervise the data bus(es) and determine the status of the system 10. A preferred embodiment of a monitoring circuit uses variable resistance to determine a status of the system. For the preferred detection data bus 16, the monitoring circuit uses a variable resistance to identify any one of: a fault condition, a normal condition, an alarm condition, a manual release condition, or an open circuit fault condition. Monitoring circuits for the other data buses can employ fewer condition determiners. The modules 14 of the system can he configured with internal circuitry 90 that communicates with the central controller 12 to determine the state in the data bus. Referring again to FIG. 2, the module 14 preferably includes an associated internal circuitry 90 in communication with the central controller 12. The internal circuitry 90 preferably includes a monitoring circuit that works in conjunction with the detection microprocessor 34 to monitor the devices associated or connected with the module 14. One embodiment of a monitoring circuit is configured with the microprocessor 34 to measure and process the voltages across a detection resistor R50 and terminal ends T1, T2 to determine the state of the monitoring, circuit. The detected status or feedback from the circuit, as defined by the detected resistance in the detection resistor R50, can be communicated from the module 14 to the central controller 12 to determine the system status of the module 14 and then displayed to a system operator or user at a display module 14z.

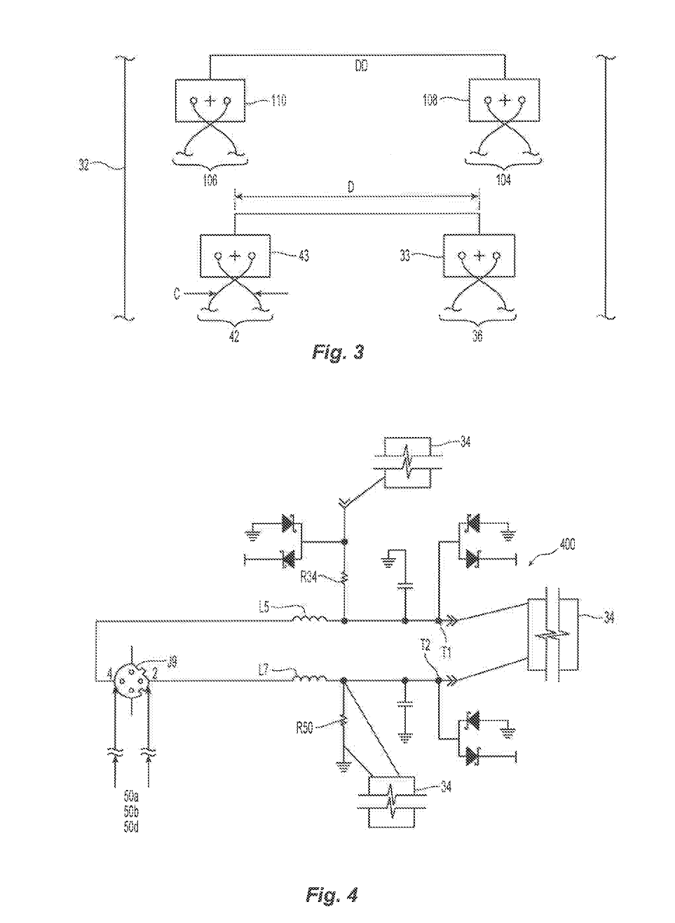

Shown in FIG. 4 is an exemplary monitoring circuit 400 that includes a first resistor R34, a first inductor L5, a mini DIN connector J9, a second inductor L7 and a second resistor R50 coupled to ground. Coupled to the mini DIN J9 can be the signal circuit defined by, for example, the internal or external thermal sensors associated with the detector module 14x. A sensing current, preferably about 200 microamps (200 μA), is sent through the first resistor R34, the first inductor L5, out pin 4 of the mini-DIN through device circuitry of the module and back through the mini-DIN J9 at pin 2, through the second inductor L7 and through the second resistor R50. The microprocessor 34 evaluates the voltage across second resistor R50 to determine if there is a fault in the module 14 and the associated devices. If it is determined that there is a voltage across second resistor R50 then there is no fault. If there is no voltage across second resistor 150, then there is a fault. To determine as to whether or not the fault is a ground fault, i.e., wire in contact with, for example, a vehicle chassis or an open circuit, the microprocessor 34 evaluates the voltage at each of the first terminal T1 and second terminal T2 of the monitoring circuit. From the voltage differential, the microprocessor 34 determines a resistance value across the terminals T1, T2. That value is communicated to the central controller 12 for determination of the state of the device circuit defined by the module 14 and its associated devices. In one particular embodiment, the state of the detection module 14x, for example, and its associated devices, is defined by the following resistance values (ohms), measured at T1, T2: i) 350-500 ohms to indicate a fault condition type signal; (ii) 700-10,000 ohms to indicate a normal state for a ready condition signal; (iii) 0-350 ohms to indicate a fire detected condition for an alarm condition signal; (iv) 500-700 ohms to indicate a manual release detection state (manual actuation); and (v) greater than (>) 10,000 ohms to indicate an open circuit fault condition type signal. Other modules 14, such as the release modules 14y or display modules 14z can use alternate resistance values with their associated internal or external devices for status determination by the central controller 14. Moreover, each of the monitoring circuits 90 of the modules 14 can be incorporated into a ground fault detection of the system 10. The sensing current is preferably taken from the power bus described herein. In order to properly detect a ground fault state, the ground of the power supply coupled to the power bus is preferably referenced or grounded to the vehicle chassis. Exemplary embodiments of a ground fault detection circuit and detection monitoring circuit is shown and described in PCT International Patent Publication No. WO2014/047579.

In addition to centralizing the operation and control of the system 10 through the various data buses, the system 10 is preferably powered through the central controller 12 and the data buses 16, 18, 20. With reference to FIG. 1, a power bus 22 is preferably initiated at the centralized controller 12 for distribution to the various modules and associated components to power the system 10. A power module 100 is preferably interconnected with the central controller 12 to power the data buses. In order to supply power to the power module 100, the power module is preferably coupled to battery power, such as for example, in the case of mobile equipment, a vehicle battery VBATT, to power the system 10.

The power for the various data buses is preferably carried along the same cabling used for data communication. Accordingly, power wires are preferably run parallel with the data wires, for example, in the RS-485 cable interconnecting the modules 14 and central controller. Like the data buses, the power supplying wires are interconnected by the printed circuit boards 32. Referring again to FIG. 2, each module 14 and its first connector 36 includes a first pair of power wires 104 mounted to the hoard 32 and the second connector 40 includes a second pair of power wires 106 mounted to the board 32. The printed circuit board 32 electrically connects the first and second pairs of power wires 104, 106. The printed circuit hoard 32 thus interconnects each of the modules 14 in series to define the preferred power bus 22, paralleling each of the data buses 16, 18, 20. The first and second pairs of power wires 104, 106 form a twisted pair and define a preferred twist rate of one inch per twist (1 in./twist) in order to minimize electromagnetic interference (EMI). Referring to FIG. 3, the first pair of power wires defines a first power mounting pad 108 on the printed circuit hoard 32 having a center, the second pair of power wires defining a second power mounting pad 110 on the printed circuit board having a center. The first and second power mounting pads define a preferred center-to-center spacing DD of 0.125 inch. Referring again to FIG. 1, in another preferred aspect of the power bus 22, the centralized controller 12 and power module 100 are integrated with a battery back-up 112. The battery back-up 112 preferably includes two back-up batteries for powering the system 10. Preferably, the central controller 12, power module 100 and battery back-up 112 are housed and integrated into a single housing. In order to facilitate maintenance of the system and avoid an accidental discharge of suppressant, the power bus preferably includes an interlock or isolation switch 129. The isolation switch 129 is preferably lockable with a customized key 129a, insertion of the key 129a into a receptacle or receiver of the switch 129 preferably generates a signal to the central controller 12 which in turn disables the automatic suppressant release capability of the system 10 as described herein. By disabling the automatic release, maintenance about the protected equipment and system can be conducted without worry of an unwanted automatic release. The key 129a as preferably customized to limit personnel able to disable the automatic release. As described herein, the system 10 cart include additional data buses, such as for example, an auxiliary data bus 24 formed with the central controller 12 for operation and control of other auxiliary components AUX of the system 10 or subsystems of the protected equipment, such as for example, audible alarms, strobe lights, etc. Alternatively or additionally, the external devices can he directly coupled to the central controller 12.

An exemplary system 10 as described herein can be set up and operated in the following manner for the protection of two or more hazard areas HA of an area to be protected. Sensors and nozzles are located within each hazard area HA to define a detection circuit and a releasing circuit of the detection and release buses for protection of the different hazard areas. The central controller 12 is programmed preferably using the display module 14z to associate or relate each of the detection and release modules 14x, 14y with a particular hazard area making each of the modules addressable for digital communication by device and hazard area. Through data communication and polling, the central controller samples status data from the detection modules 14x in a preferably programmed manner. Voltages or other data from the associated sensors of the module are conveyed to the central controller for a system status determination. Upon appropriate detection of an alarm condition, the central controller displays the condition to a user or operator at the display module 14z. In one operational aspect, the operator can either silence the condition at the display module 14z, or alternatively, manually initiate a suppressant release from the display module 14z. In an automatic programmed response, the central controller 12 can initiate a timed response to the alarm condition, which includes continued monitoring of the alarm condition from the detection modules 14x. The countdown preferably provides sufficient time for operators and other personnel to exit the vehicle or other immediate area being protected. In the alarm condition, the controller 12 can shut down the equipment being protected and countdown to a suppressant release through the release and relay modules 14y, 14yy. Upon expiration of a programmed countdown, the central controller 12 can signal select release modules 14y for electric operation of the actuation assemblies 60a. The selection of release modules is preferably based upon their association with the hazard area HA in which the fire is detected. Feedback from the pressure switches 60b and the release modules 14y permit the central controller 12 to is the suppressant release and the availability of suppressant. Upon suppression and extinguishment of the fire, the system 10 can be accessed by the display module 14z to review history logs of the system. Using the accessed data, the system can be serviced, maintained and placed in operation.

While the present invention has been disclosed with reference to certain embodiments, numerous modifications, alterations, and chances to the described embodiments are possible without departing horn the sphere and scope of the present invention, as defined in the appended claims. Accordingly, it is intended that the present invention not be limited to the described embodiments, but that it has the full scope defined by the language of the following claims, and equivalents thereof.

1. A fire suppression system comprising:
a centralized controller; and
a plurality of modules, each module including:
a housing;
a printed circuit board with a microprocessor mounted to the printed circuit board;
a first connector including a first pair of data wires mounted to the printed circuit board; and
a second connector including a second pair of data wires mounted to the printed circuit board, the printed circuit board electrically connecting the first and second pairs of data wires;
the plurality of modules being interconnected with the central controller to define at least one data bus for centralized fire detection and system response, the at least one data bus having a first end module with its first connector connected to the centralized controller and a second end module with its second connector for connection to another module, the printed circuit board of each module interconnecting the plurality of modules in series to the central controller.

2. The system of claim 1, wherein the at least one data bus is any one of a user interface bus, a fire detection bus for detecting a fire or a release bus for releasing a suppressant to suppress a fire.

3. The system of claim 2, wherein the at least one data bus is a user interface bus, and the plurality of modules include at least one display module having a user interface display mounted within the housing.

4. The system of claim 3, wherein the at least one display module includes an LCD display and a switch membrane coupled with the microprocessor of the module.

5. The system of claim 3, wherein the at least one display module includes a plurality of display modules, and the user interface bus defines a maximum bus length ranging from 1000 feet to 4000 feet.

6. The system of claim 3, wherein the at least one display module includes a USB port for connecting to a device to any one of upload a program or download a history log.

7. The system of claim 2, wherein the at least one data bus is a fire detection bus, wherein at least one module includes one of an optical sensor or an infrared sensor.

8. The system of claim 7, wherein the sensor is mounted within the housing.

9. The system of claim 7, wherein the at least one module is serially connected with a module coupled to an analog sensor being any one of a thermal detector or manual actuation device.

10. The system of claim 2, wherein the at least one data bus is a fire detection bus, wherein at least one module is coupled with an analog sensor being any one of a thermal detector or manual actuation device.

11. The system of claim 2, wherein the at least one data bus is the fire detection bus and defines a maximum bus length that ranges from 750 feet to 1500 feet.

12. The system of claim 2, wherein the at least one data bus is a release bus, the plurality of modules including at least one release module coupled to at least one actuation assembly coupled to a supply of fire suppression agent, the at least one module providing for electrical actuation of the actuation assembly to release the fire suppression agent.

13. The system of claim 12, wherein the at least one actuation assembly includes at least one electric-pneumatic actuator.

14. The system of claim 13, wherein the at least one electric-pneumatic actuator includes a protracting actuation device coupled to the at least one release module.

15. The system of claim 13, wherein the at least one electric-pneumatic actuator includes a maximum of ten (10) electric-pneumatic actuators.

16. The system of claim 12, wherein the at least one actuation assembly includes a pressure switch for feedback to the central controller through the at least one release module.

17. The system of claim 12, wherein the at least one release module is coupled to a relay module for interfacing the central controller with another system.

18. The system of claim 12, wherein the release bus defines a bus length from the central controller to the at least one release module or from the at least one release module to the at least one actuation assembly ranges up to a maximum of 250 feet.

19. The system of claim 1, wherein the first and second connectors include a male connector and a female connector.

20. The system of claim 1, wherein the plurality of modules are interconnected by serial connection cable extending between the first and second connectors.

21-37. (canceled)
